(19) United States
(12) Patent Application Publication
(10) Pub. No.: US 2022/0374483 A1
(43) Pub. Date: Nov. 24, 2022

(54) LEARNING TO RANK FOR PUSH NOTIFICATIONS

(71) Applicant: Twitter, Inc., San Francisco, CA (US)

(72) Inventor: Jonathan Hunt, San Diego, CA (US)

(21) Appl. No.: 17/661,775

(22) Filed: May 3, 2022

Related U.S. Application Data
(60) Provisional application No. 63/201,550, filed on May 4, 2021.

(51) Int. Cl. G06F 16/9535; H04L 67/55

(52) U.S. Cl. CPC G06F 16/9535; H04L 67/55; G06N 20/00

(57) ABSTRACT

Content items are recommended based on a ranking of the content items, where the ranking is based on output of a trained ranking model. The ranking model is trained using ranking loss that is based weightings of pairwise rankings of pairs of training content items selected from a set of training content items, wherein each weighting of a pairwise ranking represents a probability of receiving a negative response to a recommended content item if the pair of the pairwise ranking is misordered in a ranking of the set of training content items.

### FIELD

Embodiments relate to ranking content items for push notifications.

### BACKGROUND

Internet users can access the Internet via a mobile device. As a result, mobile devices have become increasingly important for content consumption. Push notifications can provide timely alerts to a user of a mobile device about the availability of relevant information from an application installed on the user's mobile device, even while the application is operating in the background. The push notification can prompt a user to access the information associated with the notification from the application.

Although beneficial for alerting users about the availability of relevant information, push notifications can interrupt the user flow, because they can cause the user to suspend use of one application and to switch to using another. Therefore, users may have a low tolerance for push notifications about irrelevant content items and may expect to receive notifications only for content items that are timely and important to them. Because of this, ranking the relevance of push notifications to a user and deciding which push notifications to send to the user can be important to the user experience and a demanding problem.

Learning to rank is a topic in information retrieval for designing machine learning ranking systems to surface relevant content items to users from a large corpus of content items. These ranking models are typically learned based on user feedback on content items previously presented to users. Listwise ranking is an approach to modeling the ranking problem with a loss which approximates the relative utility of a ranking of documents presented to a user, such that the more useful documents are ranked higher on the list and the effectiveness of the ranking model is evaluated and trained based on a weighted average of the rankings of many, or all, documents in the list.

### SUMMARY

Example implementations use a ranking loss based on a machine learned implementation of a weighting of a pairwise loss between candidate content items based on an expected negative response incurred for incorrectly ranking a pair of candidate content items. This technique can outperform (e.g., more likely to indicate the most relevant content for inclusion in a push notification) other ranking techniques in a social network application.

In a general aspect, a device, a system, a non-transitory computer-readable medium (having stored thereon computer executable program code which can be executed on a computer system), and/or a method can perform a process with a method including receiving a set of candidate content items, training a plurality of ranking models using a loss calculated based on weightings of pairwise rankings of pairs of training content items selected from a set of training content items, wherein each weighting of a pairwise ranking represents a probability of receiving a negative response to a recommended content item if the pair of the pairwise ranking is misordered in a ranking of the set of training content items, selecting a trained ranking model, and iterating over the set of candidate content items. The iteration including selecting a first candidate content item from the set of candidate content items, the first candidate content item having a vector representation, selecting a second candidate content item from the set of candidate content items, the first candidate content item having a vector representation, generating, using the trained ranking model, a first score based on a user feature and the first vector representation, and generating, using the trained ranking model, a second score based on the user feature and the second vector representation, and continuing the iteration over the set of candidate content items using the first candidate content item or the second candidate content item with a highest score between the first score and the second score. The method further including in response to completing the iteration over the set of candidate content items, recommending the candidate content item with the highest score from the iteration.

Implementations can include one or more of the following features. For example, the weighting of a pairwise rankings of a pair is based on a probability of a user opening a push notification associated with a training content item of the of pairs of training content items, a cumulative distribution function for the probability of the user opening the push notification in the set of training candidate content items, and a number of training content items in the set of training candidate content items. The probability of the user opening the push notification associated with the training content item corresponds to a click through rate (CTR) for the training content item being predicted as a top ranked candidate. The generating of the first score includes estimating a CTR for the first candidate content item, and the generating of the second score includes estimating a CTR for the second candidate content item. The method can further include grouping the received set of candidate content items based on a user type, wherein the first candidate content item and the second candidate content item are selected from a same group of the received set of candidate content items. The predicting of the expected negative response uses a trained neural network. The recommending of the content item with the highest score includes communicating a push notification associated with the recommended content item to a user.

The training of the trained ranking model can include combining pointwise losses and pairwise losses and using a logistic regression. The method can further include comparing the highest score to a threshold value, and in response to determining the highest score is greater than or equal to the threshold value, recommending the content item with the highest score to a user through communication of a push notification associated with the recommended content item. The recommending the content item with the highest score includes communicating a push notification associated with the recommended content item to a user, and the method can further include determining whether or not the push notification was responded to, and in response to determining the push notification was not responded to, updating the user feature. The recommending the content item with the highest score includes communicating a push notification associated with the recommended content item to a user in a social media platform, wherein the user feature represents interactions of the user with the social media platform, where the user feature represents interactions of the user with the social media platform. The probability of receiving the negative response to the recommended content item represents a likelihood the user will disregard or reject the recommended candidate content item. The loss can be calculated as:

lₑᵣ(u,θ)=Σ_{X}_{ₚₒₛ}Σ_{X}_{_{neg}}wₑᵣ(xₚₒₛx_{neg})×max(pairwise loss)

where:

xₚₒₛ is a value representing a content item with a positive response,

x_{neg} is a value representing a content item with a negative response, and

pairwise loss represents a function for a pairwise loss algorithm.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a flow diagram for training and using a ranking model according to an example implementation.

FIG. 2 illustrates a flow diagram for using a ranking model to predict click through rate (CTR) according to an example implementation.

FIG. 3 illustrates a flow diagram for generating a push notification according to an example implementation.

FIG. 4A illustrates a block diagram of an architecture for a pairwise ranking model according to an example implementation.

FIG. 4B illustrates a block diagram of a convolutional neural network architecture according to an example implementation.

FIG. 5 illustrates a block diagram of a method for generating a push notification according to an example implementation.

FIG. 6 illustrates a block diagram of a method for training a ranking model according to an example implementation.

FIG. 7 illustrates a block diagram of a system for generating a push notification according to an example implementation.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Changes in technology have resulted in new modes of content consumption by user. For example, on mobile devices users can choose to receive “push notifications” to be alerted in a timely manner to relevant new content that is available on the users' devices.

New content that can be considered for a push notification can include a plurality of candidate content items. However, as explained above, often it is desirable to use push notifications sparingly, so as not to interrupt a user's workflow too much, thus ensuring that the user will consider a push notification as a helpful alert about the existence of relevant and timely content, rather than as an unwelcome distraction. Thus, a push notification system should choose a candidate content item that the user is likely to open for inclusion in the push notification. A push notification that includes a candidate content item that the user opens can be referred to as a candidate content item having a positive response. A push notification that includes a candidate content item that the user disregards or rejects can be referred to as a candidate content item having a negative response. The push notification system should be configured to prevent generating push notifications that cause a negative response. Because push notifications are generally served singly to a user, rather than in a list of many notifications, the push notification should emphasize the ranking of the top ranked notification, rather than considering a weighted average of the top N (with N>1) ranked push notifications.

When considering the relative relevance/importance to a user of two of the plurality of candidate content items, the push notification system can be configured to compare the two candidate content items and rank the relative relevance/importance to the user of two candidate content items. This is sometimes called pairwise ranking. For example, the candidate content item of the two candidate content items that is more likely to cause a negative response can be the lower ranked content item of the two candidate content items. Using the pairwise ranking technique, the push notification system can be configured to predict a numeric value for an expected negative response for each of the two candidate content items, and the numeric values can be used to perform a relative ranking of the two candidate content items. The push notification system can be configured to discard the lower ranked candidate content item (i.e., the item that has a numeric value indicating that it is more likely to have a negative response) and continue with the pairwise ranking of the plurality of candidate content items. The last remaining candidate content item can be the content item included in the push notification.

This pairwise expected negative response technique is concerned with identifying the candidate content item with the lowest expected negative response, whereas correctly identifying the ranking order of the remainder of the plurality of candidate content items is not an object of the push notification system. Example implementations can use a machine learned (e.g., trained) ranking model that predicts an expected negative response for each candidate content item from a large corpus of content items using the pairwise expected negative response technique.

Use of the trained or machine learned ranking model improves the functioning of a computer, because fewer CPU cycles/memory read/writes are required to achieve a desired accuracy of recommendation as compared with existing techniques of ranking candidate content items. Using fewer CPU cycles/memory read/writes can also use less power. Use of the trained or machine learned ranking model improves the quality of the push notifications sent to a user. Higher quality push notifications can improve the functioning of a computer (e.g., the user device on which an application is operating), because fewer CPU cycles/memory read/writes are required to achieve a desired accuracy of recommendation as compared with existing techniques of ranking candidate content items. Using fewer CPU cycles/memory read/writes can also use less power.

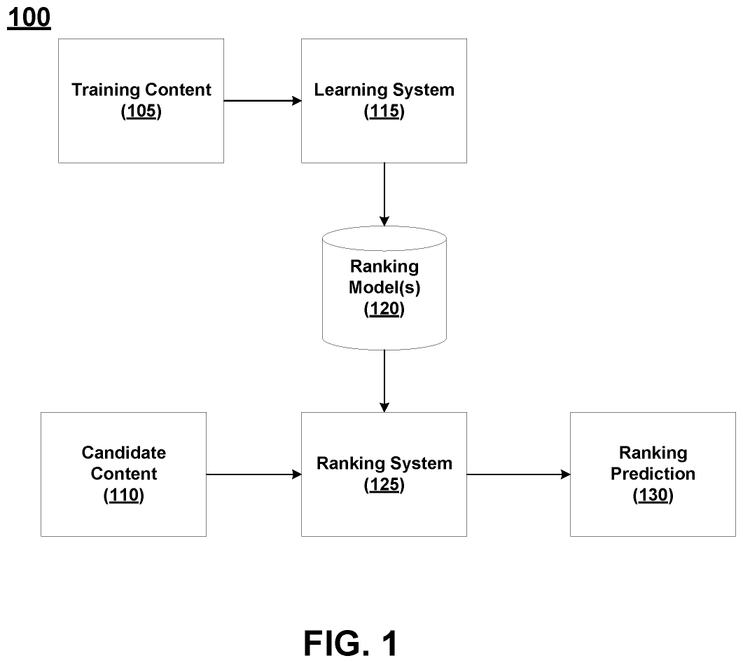

FIG. 1 illustrates a flow diagram for training and using a ranking model according to an example implementation. As shown in FIG. 1, the flow diagram 100 includes a training content 105 block, a candidate content 110 block, a learning system 115 block, a ranking model(s) 120 block, a ranking system 125 block, and a ranking prediction 130 block.

The ranking model(s) 120 can be configured to predict an expected negative response for each candidate content item selected from a large corpus of content items using the pairwise expected negative response technique. Example implementations can use a ranking loss that is a weighted loss based on pairwise losses. A negative response can be incurred if a pair was not ordered correctly in the ranking (e.g., resulting in a push notification associated with a content item that is not of interest to the user). The loss can be over pseudo-candidate sets, such that different ranking models can be trained for different user types. A pseudo-candidate set can include using a batch of candidate content items and grouping the candidate content items by user type. The loss can be calculated based on labeled training data, as described in more detail below.

The training content 105 can be historical content items that can be used to train at least one ranking model of the ranking model(s) 120. Training the ranking model(s) 120 can include modifying the weights and/or parameters associated with the ranking model. For example, the ranking model(s) 120 can be trained to achieve the best ranking that results in identifying a single content item, of a large corpus of content items, that would be served in a push notification. The training content 105 can include ground truth information. The candidate content 110 can be operational content and/or testing content. The candidate content 110 can include a plurality of content items. Content corresponding to the training content 105 and/or the candidate content 110 can be content that can be ranked based on interest, relevance, personalization, significance, and/or the like to a user. Content items corresponding to the training content 105 and/or the candidate content 110 can include documents, web pages, blogs, podcasts, posts, social media posts/replies, and/or the like. Therefore, training content 105 can be, for example, historical social media posts/replies and candidate content 110 can be, for example, current or live social media posts/replies.

The learning system 115 can be configured to use the training content 105 to train a ranking model of the ranking model(s) 120 and/or train a ranking model to be stored in the ranking model(s) 120 (e.g., a newly created ranking model that will be stored after training is complete). A ranking model can be or can include a neural network (e.g., deep-learning, a two-dimensional (2D) convolutional neural network (CNN), etc.) trained to generate or help generate the content items ranking including being trained to identify features associated with the content items. Training the neural network (of the ranking model(s) 120) can include using data sets with labeled (and, therefore, identified) content items ranking, such that the learning system 115 can be configured to use a supervised learning technique. In some implementations, unsupervised learning techniques can be used, for example, for classification of data.

The learning system 115 can be configured to train a ranking model of the ranking model(s) 120 by modifying weights associated with the model being trained. The ranking model of the ranking model(s) 120 can be trained for distinguishing between features of the content items and identifying relationships between features and a user (e.g., the user that a push notification may be sent to). Each ranking model in the ranking model(s) 120 can have an associated weight(s). The associated weights can be randomly initialized and then revised in each training iteration (e.g., epoch). The training can be associated with implementing (or helping to implement) distinguishing between two or more content items and identifying relationships (e.g., interest) between content items and users. In an example implementation, a labeled input content items set (e.g., documents with labels indicating a ranking order of the documents and/or the highest ranked document) and the predicted ranking can be compared. A loss can be generated based on the difference between the labeled ranking and the predicted ranking. Training iterations can continue until the loss is minimized and/or until loss does not change significantly from iteration to iteration. In an example implementation, the lower the loss, the better the predicted ranking.

The ranking model(s) 120 can include a plurality of ranking models as neural networks (e.g., deep-learning, a two-dimensional (2D) convolutional neural network (CNN), etc.) trained to generate or help generate the content items ranking. The ranking system 125 can be configured to use a trained ranking model from the ranking model(s) 120 to rank content items from the candidate content 110. The ranking system 125 can be configured to select a trained ranking model from the ranking model(s) 120 to generate the ranking prediction 130 based on the candidate content 110 using the selected trained ranking model. The ranking prediction 130 can include a score for each content item in the candidate content 110. The score can be based on a predicted click through rate (CTR). The content item with the highest score can correspond with content item to be communicated with a push notification. As mentioned above, content items not associated with the highest score ranking order may be insignificant for purposes of training the ranking model(s) 120. In other words, the ranking model(s) 120 can be trained without considering a user's predicted response (e.g., positive response and/or negative response) to the content items ranked second thru N^{th} in the ranking of the content items.

Algorithm 1 shows pseudocode of a notification system. U denotes the set of users, and X denotes the space of features of content items. A pass is made through a set of users periodically, and candidate content items for each user can be obtained and scored using a scoring function ƒ. For example, parameterization by θ, ƒ_{θ}(u, x): U×X→ [symbol] can be used to score the candidate content items. The highest scoring content item of the candidate content items can be sent as, for example, a push notification to the user, and the user's response (e.g., binary variable, for example, y=1 if the user opens the notification or y=0 if the user does not open the notification) can be logged and used to train subsequent ranking models.

The objective of the ranking system can be to identify content items relevant to the user based on the user choosing to open notifications associated with content items rather than the user choosing to ignore or choosing to dismiss the notifications. Algorithm 1 is pseudo-code of a single pass of a ranking model based push notification system. At each iteration (e.g., loop, periodic, notification initiation time, and the like), a set of candidate content items for a user can be obtained (note: this set can be distinct for each user and each iteration of the loop because new content items can be being created), ranked, and the highest scoring candidate content item can be sent as a push notification to the user.

Algorithm 1

```
Accept scoring function ƒ_{θ}(u, x)
for u ∈ U do
  Obtain available candidate content{x₁, ... , xₙ} for user u available at
  this time.
  Find the highest scoring content x = arg max_{x∈{x}_{₁}_{,...,x}_{ₙ}_{}} ƒ_{θ}(u, x)
  Send the corresponding content to the user and receive a response y ∈
  {0,1}
  Log u, x, y
end for
```

Push notifications delivered on a social media platform can have characteristics that make ranking of the push notifications challenging and distinct from many other existing ranking problems. For example, of all the candidate content items for which a push notification might be sent to a user, a ranking of the candidate content items generally selects only a single candidate content for which a push notification is sent to the user. In addition, feedback from a user response to a received push notification for only one content item may be received at a time because of the display limitations of push notifications. The limitations can include a notification icon that can indicate a number (e.g., an icon with a number embedded) of unread notifications, a user interface that is independent of the social media feed and displayed via interaction with the notification icon, feedback received only if the user clicks-through on a notification via the user interface, no feedback received even if the user reads the notification when there is no click-through, the necessity to scroll through notifications in the user interface that can cause notifications of interest to be missed because the user may not scroll, limited feedback because of a limited number of push notifications sent per day, the mixing of other types of notifications with the push notifications, and/or the like. This can be of significance when considering what is the appropriate ranking loss below, and distinct from many other ranking problems.

For example, a content item relevance can be relevant to a user and/or personalized for the user. Unlike some other content item consumption routes, users can receive push notifications without actively interacting with an application. Therefore, there can be limited context (e.g., in a search engine if several users search for the same keywords, the responses could be grouped together). This degree of personalization suggests that the push notification may not be valid to a plurality of user responses to the same content item.

For example, user responses may be static in time. That is, a content item may be relevant to the user now, but not relevant a short time in the future. For example, users make use of some applications to obtain information on breaking news, and the users may value the timeliness of the news. Therefore, a content item sent to a user promptly when the news is breaking may be opened by a user, while the same content item sent at a later time may be irrelevant and dismissed.

For example, new content items may be created frequently. Therefore, ranking approaches should be generalized to content items that have not been seen before (e.g., by the same user). Each time a set of candidate content items is ranked, both this set and many individual candidate content items in the set may have never been seen by the system before.

The push notification characteristics can combine to make estimating counterfactual outcomes challenging. By contrast, in a search engine where the user views multiple results, after correcting for position bias, some assumptions to estimate the performance of a ranking with a different ordering of the same content can be possible. The personalization problem (i.e., that different users respond uniquely to the same push notifications) and the non-stationarity problem (i.e., that many push notifications can have time-dependent relevance to the user, which depends on when the user sees/opens the notification) can combine to suggest that averaging multiple user responses together to obtain better relevance estimates than binary labels may not be possible.

In push notifications, only the top ranked content item is sent as a push notification to the user and all other content item can have no effect (e.g., the user will not see the content item as a push notification) on the outcome. Therefore, example implementations, solve the above problems using deterministic policies and/or stochastic policies. For example, a push notification policy can be defined as π: u×{x₁, . . . , xₙ} as a mapping from a user u and an unordered candidate set of content items {x₁, . . . , xₙ} to one content item in that set x. Note that the ordering over content items in the set is arbitrary. The chosen content item x=π(u, {x₁, . . . , xₙ}) results in a positive response r(u; x)=y based on an action of the user y∈{0,1}, who may either open the content item (y=1) or dismiss the content item (y=0).

The positive response is stochastic, as there are many unobserved factors which affect the outcome (e.g., a relevant notification sent when the user is busy may be dismissed). In an example model, each content item can be identified as having a latent likelihood of being opened if a notification is sent to the user \tilde{y}=p (y=1|u, x) which defines a Bernoulli distribution. In the example, the latent p(y=1|u, x) for each content item is accessible. In addition, a deterministic positive response function can be defined as rₛᵢₘ(u, x)=p(y=1|u, x). Note that rₛᵢₘ= [symbol] _{p(y|u,x)}r(u,x). This latent variable may not be used in training but allows for an evaluation of the ranking algorithms with lower variance.

A negative response that is incurred by a ranking policy π for a particular user u and candidate set of content items {x₁, . . . , xₙ} is represented as:

$$g ( u , \{ {x}_{1} , … , {x}_{n} \} , π \} = {max}_{{x}_{j ∈ \{ {x}_{1} , … , {x}_{n} \}}} {r}_{sim} ( u , {x}_{j} ) - {r}_{sim} ( u , π ( u , \{ {x}_{1} , … , {x}_{n} \} ) ) . \qquad ( 1 )$$

Parametrizing the ranking policy for all methods can include using a scoring function ƒ_{θ}:U×X→ [symbol] that maps user features and content item features to a real-valued score, ƒ_{θ} is parameterized by θ. In other words, the function ƒ can be a function configured to map an input (e.g., features associated with content items and a user) to an output (e.g., a score of the content item). The function can be defined by parameters θ (e.g., numeric variables). The function can be a neural network and/or a linear function. The neural network can include a plurality of parameters θ, and the parameters θ used can be trained by optimization using the below described loss functions. The highest scoring content item is selected π(u, {x₁, . . . , xₙ})=argmax_{x∈{x}_{₁}_{, . . . ,x}_{ₙ}_{}}ƒ_{θ}(u,x).

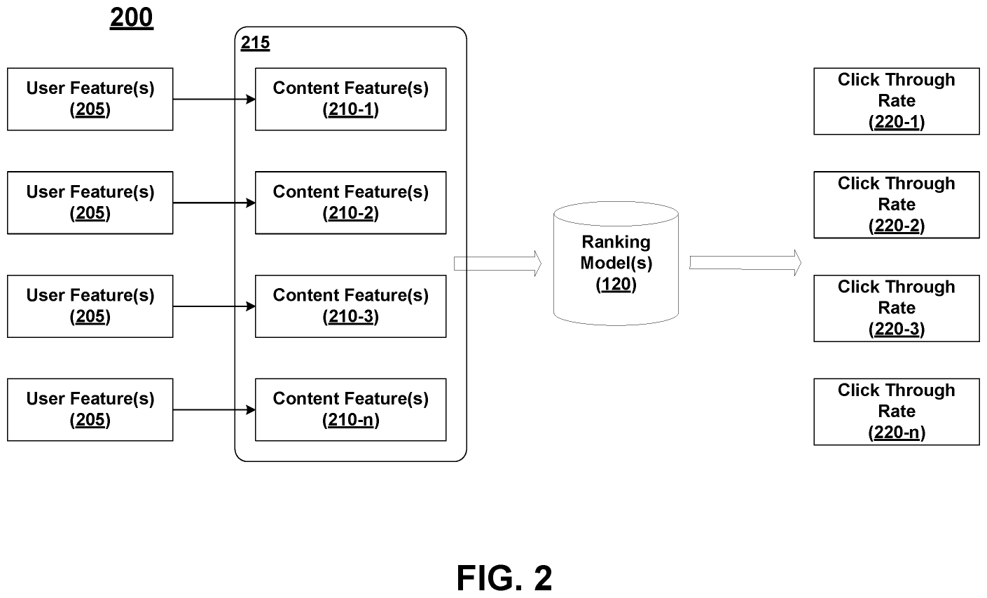

FIG. 2 illustrates a flow diagram for using a ranking model to predict a click through rate (CTR) according to an example implementation. As shown in FIG. 2, the flow diagram 200 includes a user feature(s) 205 block, a candidate set 215 block including content feature(s) 210-1, 210-2, 210-3, 210-n blocks, the ranking model(s) 120 block, and click through rate (CTR) 220-1, 220-2, 220-3, 220-n blocks.

The user feature(s) 205 can be feature variables representing interest, relevance, personalization, significance, and/or the like to a user. The user feature(s) 205 can be a vector or an array of scalar values, each value representing a feature. For example, a vector for a social network can have vector variables associated with a user's likes, dislikes, follow topics, search topics, and/or the like. An example vector could be associated with a sport (e.g., soccer, football, baseball, basketball, and/or the like). If the user follows the sport, the vector variable could be a first binary value and if the user does not follow the sport, the vector variable could be a second binary value. Other techniques for building the user feature(s) 205 (e.g., vector, array, and/or the like) are possible. For example, user information could be kept in a data structure (e.g., a knowledge graph) and a vector can be generated from the data structure associated with the user.

The content feature(s) 210-1, 210-2, 210-3, 210-n can include information associated with the content in, for example, a vector form or form similar to the form of the user feature(s) 205. The content can be documents, web pages, blogs, podcasts, posts, social media posts/replies, and/or the like. Therefore, content feature(s) 210-1, 210-2, 210-3, 210-n can include, for example, the author or topic of the document, web pages, blogs, podcasts, posts, social media posts/replies, and/or the like. The candidate set 215 can combine the user feature(s) 205 with each of the content feature(s) 210-1, 210-2, 210-3, 210-n.

The ranking model(s) 120 can include a plurality of ranking models as a linear function or as neural networks (e.g., deep-learning, a two-dimensional (2D) convolutional neural network (CNN), etc.) trained to generate or help generate the content ranking. The trained ranking model from the ranking model(s) 120 can be used to rank content from the candidate set 215. As discussed above, the ranking system 125 can be configured to select a trained ranking model from the ranking model(s) 120 to rank content items from the candidate set 215. The CTR 220-1, 220-2, 220-3, 220-n can be associated with the ranked content items. For example, the CTR 220-1, 220-2, 220-3, 220-n can include a score representing the CTR predicted for the candidate set 215. For example, the higher the predicted CTR 220-1, 220-2, 220-3, 220-n, the higher the score, and the higher the ranking.

As mentioned above, only the highest ranked content item may be associated with a push notification. Therefore, content items not associated with the highest-ranking content item (e.g., the content feature(s) 210-1, 210-2, 210-3, 210-n with the highest predicted CTR) may be insignificant for evaluating the performance of the ranking model. In other words, content items ranked second thru N^{th} can be in any order without affecting the relevance of a push notification.

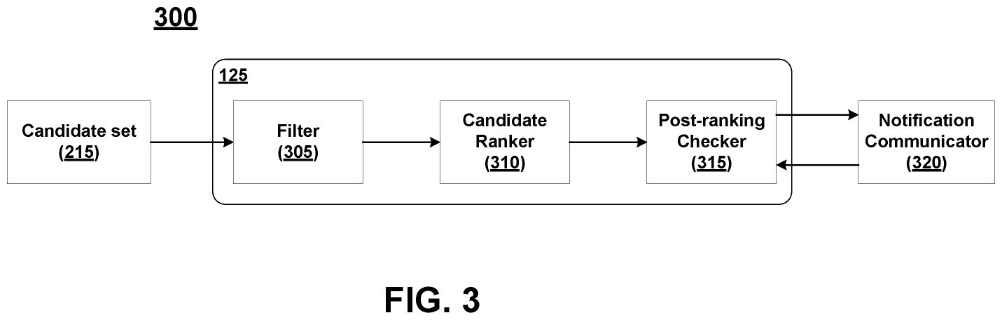

FIG. 3 illustrates a flow diagram for generating a push notification according to an example implementation. As shown in FIG. 3, the flow diagram 300 includes the candidate set 215 block, the ranking system 125 block including a filter 305 block, a candidate rank 310 block, and a post-ranking checker 315 block, and a notification communicator 320 block.

The filter 305 block can be configured to remove content items from the candidate set 215. For example, the user can have some identifiable interests and/or time-based (e.g., recent) interests. The filter 305 block can be configured to remove content items from the candidate set 215 that are not relevant to the identifiable interests and/or time-based interests. For example, the user can have an interest relationship (e.g., share common interests). The filter 305 block can be configured to remove content items from the candidate set 215 that are not associated with the interest relationship of the user (sometimes called collaborative filtering). The filter 305 block can also be configured to remove features from the candidate set that may have minimal or no impact on the ranking of the content items. For example, if the user has no interest in a certain topic, the feature associated with the content items can be removed. For example, as discussed above, the data structure including a vector or an array of scalar values representing a feature may not include a value representing the feature associated with the content item of no interest. The value representing the feature may not be included in the vector or array of scalar values because the feature was removed (e.g., filtered) from the candidate set and/or the value representing the feature was removed (e.g., filtered) from the vector or array of scalar values. If the user is located in a first region, features associated with a second region can be removed. If a feature is nonexistent in all (or substantially all) candidates, the feature can be removed from all candidates. These are just a few examples of filter 305 the candidate set 215.

The candidate rank 310 can be configured to rank the content items included in the candidate set 215 (or the filtered candidate set 215) for the user corresponding to the user feature(s) 205. Ranking the candidate content items can include using a ranking technique. The ranking technique can include at least one of (described in more detail below) a pointwise ranking technique, a pairwise ranking technique, a listwise ranking technique, and the like. The candidate rank 310 can be configured to calculate a ranking loss to determine a higher and/or highest-ranking content item. The candidate rank 310 can be configured to pool content items, group content items by user type, predict an expected negative response and/or Click Through Rate (CTR), and/or weigh possible positive and/or negative responses.

The post-ranking checker 315 can be configured to perform a check on the ranking before a push notification is communicated to the user and after the push notification is communicated to the user. Before the push notification is communicated to the user, the post-ranking checker 315 can be configured to check whether or not a variable associated with the ranking of the content item is above (e.g., greater than or equal to) a threshold value. For example, the post-ranking checker 315 can determine whether or not the CTR for the content item is above a threshold value. If the CTR is above the threshold value, information associated with the content item can be communicated to the notification communicator 320. Otherwise, no information is communicated to the notification communicator 320.

In response to receiving information associated with the content item, the notification communicator 320 can be configured to communicate a push notification associated with the content item to the user. If no information associated with the content item is received by the notification communicator 320, no push notification is communicated to the user. The notification communicator 320 can be further configured to determine whether or not the user responds to the push notification. The user can have one (1) of (2) responses. The user can open the content item (click-through) or clear the push notification. In addition, the user may not respond to (e.g., ignore) the push notification. The notification communicator 320 can be configured to communicate feedback to the post-ranking checker 315. Therefore, after the push notification is communicated to the user, the post-ranking checker 315 can be configured to check whether or not the user responded negatively (e.g., a negative response as discussed above) or positively (e.g., a positive response as discussed above). For example, the user can respond negatively if the user clears the push notification or does not respond to the push notification. Further, the user can respond positively if the user opens the content item associated with the push notification.

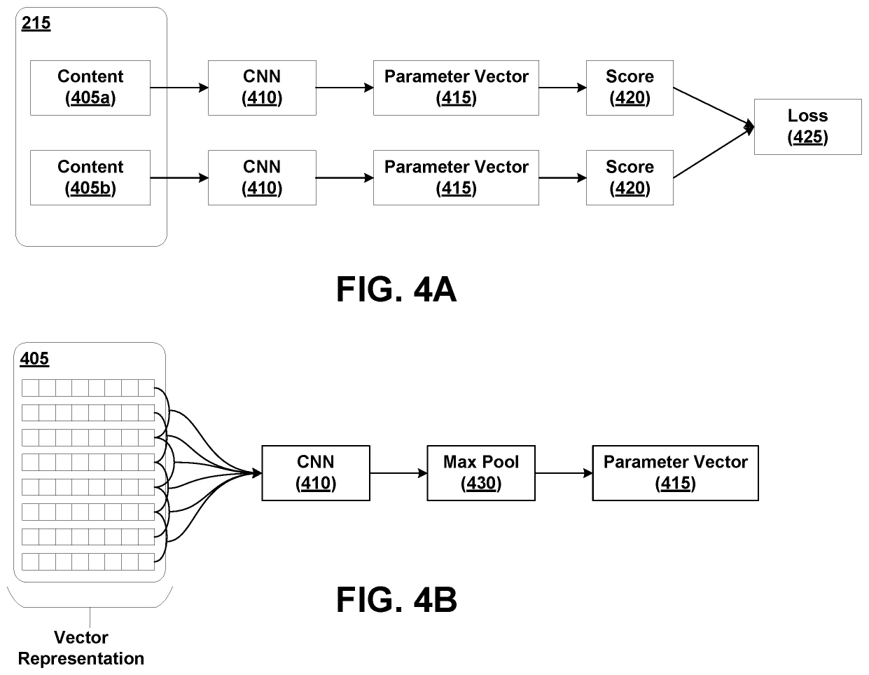

FIG. 4A illustrates a block diagram of an architecture for a pairwise ranking model according to an example implementation. As shown in FIG. 4A, the architecture includes the candidate set 215 block including content 405a and 405b, a convolutional neural network (CNN) 410 block, a parameter vector 415 block, a score 420 block, and a loss 425 block. FIG. 4B illustrates a block diagram of a convolutional neural network architecture according to an example implementation. As shown in FIG. 4B, the architecture includes a content 405 block, the CNN 410 block, a max pool 430 block, and the parameter vector 415 block.

Content 405a and 405b can be independently input to the convolutional neural network (CNN) 410. The CNN 410 can be configured to generate the parameter vector 415 as a learned vector representation of the content 405a and 405b. In an example implementation, each content 405a and 405b can be represented by content 405 representing a post (e.g., a social media post) including words. The words can be transformed into vector representations using a word embedding matrix, which capture semantic information of the words. In CNN 410, a convolutional layer and a set of filters is applied to a sliding window of length h over the vector representations of the content 405 to extract a set of features. Zero-padding can be applied to the input at both ends prior to convolution ensuring that the filters can be applied to every element of the input matrix. The filters can be learned during a training phase of the CNN 410.

The max pooling 430 can perform a max operation over a local neighborhood to retain only the most useful local features produced by the CNN 410. The max pooling 430 can include a fully connected layer (prior to output) that can compute (e.g., using a sigmoid activation function) a non-linear transformation of the local features. The non-linear transformation of the local features can be the parameter vector 415. A score 420 for the parameter vector 415 can be generated (e.g., as a CRT) and the loss 425 can be calculated based on two scores 420. The loss 425 can indicate which of content 405a and 405b should be ranked higher. Below is a more detailed description of calculating the loss for different techniques of ranking. The loss can be calculated with a neural network (e.g., a CNN) and/or with a linear function.

A first technique (sometimes called pointwise ranking) for calculating ranking loss can be to treat the ranking problem as a classification problem on the outcome y and use the cross-entropy loss to train a score function with empirical risk minimization to predict the likelihood that a content will be opened. In general, the loss used in training a pointwise ranking model can be used, for example, to train the model to predict relevance scores for a set of content items. The loss is:

l_{ce}(u,θ)=Σₓ_{ₚₒₛ}_{∈X}_{ₚₒₛ}−log(σ(ƒ_{θ}(u,xₚₒₛ)))−Σₓ_{_{neg}}_{∈X}_{_{neg}}−log(σ(ƒ_{θ}(u,x_{neg}))) (2)

where:

xₚₒₛ is a value representing a content item with a positive response,

x_{neg} is a value representing a content item with a negative response, and

a sigmoid function σ used to bound the prediction ƒ_{θ}(u, x) to (0, 1).

A second technique (sometimes called pairwise ranking) for calculating ranking loss can focus on the relative ordering of two content items (with different outcomes). Other pairwise ranking algorithms (e.g., logistic pairwise loss) can be used. In general, a loss used for training a pairwise ranking model can be used to estimate a relative ranking of a set of content items. The loss can be based on a bound scores (e.g., a score between 0 and 1) associated with the highest ranked (e.g., maximum score) associated with two content items. The two content items can include a content item with a positive user response (xₚₒₛ) and a content item with a negative user response (x_{neg}). The loss is:

lₚₐᵢᵣ(u,θ)=Σₓ_{ₚₒₛ}_{∈X}_{ₚₒₛ}Σₓ_{_{neg}}_{∈X}_{_{neg}}max(0,1−(ƒ_{θ}(u,xₚₒₛ)−ƒ_{θ}(u,x_{neg}))) (3)

where:

xₚₒₛ is a value representing a content item with a positive response, and

x_{neg} is a value representing a content item with a negative response.

The loss can cause the score function to score content with a positive label higher than negative content. A third technique (sometimes called listwise ranking) for calculating ranking loss can be used to approximate the utility of the ordering of the set more directly, for example, to distribute the error in the rankings for individual content items over the entire set of items. The closest prior example to the loss can be the K-Order Statistics Loss (K-OS) AUC loss which can incorporate ranking information into a pairwise loss. K-OS first computes an ordering over the positive examples based on the current scores of the model being optimized (xₚₒₛ¹, . . . , xₚₒₛ^{|X}^{ₚₒₛ}^{|}). The loss (sometimes referred to as a margin ranking loss) can represent a discrepancy between a known score (ranking or relative ranking) and the predicted score (ranking or relative ranking) of the relevance of a content item to a user. The loss is:

$${l}_{K - OS - AUC} ( u , θ ) = \frac{1}{Z} {\sum }_{i = 1}^{\vert {X}_{pos} \vert} W ( \frac{i}{{X}_{pos}} ) {\sum }_{{X}_{neg}} max ( 0 , 1 - ( {f}_{θ} ( u , {x}_{pos}^{i} ) - {f}_{θ} ( u , {x}_{neg} ) ) ) \qquad ( 4 )$$

$$where Z = {\sum }_{i} W ( \frac{i}{{X}_{pos}} ) ,$$

and
W weights pairs by their rank.

If W(j)=C for all j, and C is a positive constant, K-OS loss associated with the first technique reduces to the loss of the first technique; if W(i)>W(j) when i<j, the third technique will penalize errors on high ranked positive items more. In an example implementation,

$$W ( \frac{i}{\vert {x}_{pos} \vert} ) = 1$$

for i=1 and 0 otherwise to reflect that only the highest ranked content may be relevant to the outcome in push notifications. In another example implementation, a weight capping approach can be used for comparison with the loss introduced (see equation 8) below where

$$W ( \frac{i}{\vert {x}_{pos} \vert} ) = k < 1$$

for i>1, so that lower ranked positive examples contribute to the loss, just at a reduced weight. In this example implementation, k can be a hyperparameter and include k=0 (where loss reduces to the original K-OS loss) in the hyperparameter search space.

Example implementations can group by user type. For example, users of a social platform can be categorized into different user types based on their usage of the social platform. The behavior of users in response to push notifications received through a social media platform varies by user type (e.g., a user who uses the social platform every day may be more likely to open a notification than an occasional user). Example implementations use a ranking loss that is a weighted loss based on pairwise losses. A negative response can be incurred if a pair was not ordered correctly in the ranking (e.g., resulting in a push notification associated with a content that is not of interest to the user). The loss can be over pseudo-candidate sets. A pseudo-candidate set can include using a batch of candidate content and grouping the candidate content by user type. The loss can represent a weighted pairwise ranking of pairs of content items from a set of content items. The weighting of the pairwise ranking for a pair of content items can represent a probability of receiving a negative response to a recommended content item if the pair of content items is misordered in a ranking of the set of training content items. The loss is:

lₑᵣ(u,θ)=Σ_{X}_{ₚₒₛ}Σ_{X}_{_{neg}}wₑᵣ(xₚₒₛx_{neg})×max(0,1−(ƒ_{θ}(u,xₚₒₛ)−ƒ_{θ}(u,x_{neg}))) (5)

noting that max (0,1−(ƒ_{θ}(u,xₚₒₛ)−ƒ_{θ}(u,x_{neg}))) could be replaced by a function for calculating any other type (e.g., logistical) pairwise loss. Therefore, equation (5) could be written as:

lₑᵣ(u,θ)=Σ_{X}_{ₚₒₛ}Σ_{X}_{_{neg}}wₑᵣ(xₚₒₛx_{neg})×max(pairwise loss) (5.5)

where: pairwise loss represents a function for a pairwise loss algorithm.

The weighting of each pairwise loss wₑᵣ(xₚₒₛ, x_{neg}) denotes that for each content item receiving a positive response xₚₒₛ there can be three additional pieces of information: the probability of the user opening the content \tilde{y}=p(y=1|xₚₒₛ, u) (note: \tilde{y}∈[0,1] may not be binary), the cumulative distribution function for \tilde{y} for this candidate set (denoted as F(\tilde{y})) and the number of candidates in the candidate set n. Knowledge of \tilde{y} may be unrealistic, and may be removed. However, F(\tilde{y}) can be estimated from logged data, and n may be known.

The weighting, wₑᵣ, can be computed for a pair by computing the expected negative response in Click Through Rate (CTR) incurred if the model did not generate a correct order for the current pair (e.g., the pair of content being compared for ranking) in the set of candidate content. The negative response incurred for not ordering any candidate content correctly, but the top ranked candidate is zero (0) because one candidate is identified as a possible content for a push notification. Therefore, the weighting model can be decomposed into two parts: (1) the probability xₚₒₛ is the top-ranking candidate and (2) the expected negative response if x_{neg} is sent rather than xₚₒₛ.

The probability that a candidate with a CTR of \tilde{y}ₚₒₛ is the top ranked candidate in a candidate set of size n is:

pₜₒₚ(\tilde{y}ₚₒₛ)=(1−F(\tilde{y}ₚₒₛ))ⁿ⁻¹. (6)

If the content xₚₒₛ should have been the top-ranked content and was not ordered correctly and communicated to the user x_{neg} instead, then a negative response will be incurred in the expected CTR of \tilde{y}ₚₒₛ−\tilde{y}_{neg} Therefore, the expected negative response of not ordering a content pair correctly is:

w′ₑᵣ=pₜₒₚ(\tilde{y}ₚₒₛ)×(\tilde{y}ₚₒₛ−\tilde{y}_{neg}), (7)

wₑᵣ=max(w′ₑᵣ,k) (8)

and the weights can be bound so the weights may not be negative or completely ignored.

The loss of equation (5) can use \tilde{y} when weighting the candidate content pairs. If the latent value of a content item is known, the optimal ranking would be known. However, the latent value of a content may not be known. Therefore, the latent value of a content can be unworkable. In an example implementation, for the purposes of weighting pairs, \tilde{y} approximately can be approximated. Therefore, knowledge of the latent value of a content is not necessary.

The estimated CTR can be used for weighting and the labels can be used for generating candidate content pairs. Therefore, errors in the CTR estimate may result in weighting a pair imperfectly but will not result in the loss ranking a negative content above a positive content. However, to avoid doubling the training time, by requiring first training a pointwise loss and then the loss of equation (5), the same model can be used, and both losses can be trained simultaneously. Combining pointwise and pairwise losses can be used with logistic regression. However, the losses between the pairwise and pointwise loss should be compatible. A pairwise and pointwise loss can be compatible if they are designed such that it is possible for the model to minimize both losses simultaneously for a pair of items. For example, using a pairwise hinge loss which is 0 if the positive item has a score greater than 1+negative content item. Therefore, if the pointwise loss is minimized when a positive content item has a score of 1 and the negative content item has a score of 0, then the model can simultaneously minimize both losses.

An l₂ pointwise loss and the label values 1, −1 for the l₂ loss can be used such that for any pair xₚₒₛ, x_{neg} there is a solution that minimizes both the pairwise and pointwise loss. These losses can be added together with a hyperparameter a to control their relative contribution to the final loss. Estimate 0 and use this estimate to weight the pairwise loss.

Algorithm 2 illustrates how these losses can be combined to simultaneously learn both a CTR estimate or model, and, using this estimated CTR, to learn the weights for the pairwise loss.

Algorithm 2

```
Initialize θ
for training iterations do
  Sample pair of examples (uₚₒₛ, xₚₒₛ), (u_{neg}, x_{neg})
  Estimate CTRs \tilde{y}′ₚₒₛ = ƒ_{θ}(uₚₒₛ, xₚₒₛ), \tilde{y}′_{neg} = ƒ_{θ}(u_{neg}, x_{neg})
  Compute wₑᵣ using eqn. 7 and the estimated values \tilde{y}′ₚₒₛ, \tilde{y}′_{neg}
  Compute loss lₑᵣ using equation (5)
  Sample pointwise sample uᵢ, xᵢ, yᵢ
  Compute pointwise loss l₂
  Update θ to minimize loss
    l = lₑᵣ + αl₂ (9)
end for
```

The log data can consist of user candidate pairs (u₁, x₁, y₁), (u2, x₂, y₂), . . . which differ in both the user attributes u and content x and user responses y because the requirement to send one notification associated with a single content item from a candidate content items set. However, when ranking, various content items may be considered for a single user. Therefore, the candidate content items set can have the same user attributes for every content item (u, x₁), (u, x₂), . . . . The labels y for the other content items are not known because a single notification can be sent at a time. Therefore, as described above, in order to apply pairwise or listwise losses candidate content items sets were grouped to the user into pseudo-candidate sets, and responses by different users of a particular set to individual content items were taken as representative of all users in the set.

An alternative (and/or additional) approach to pseudo-candidate sets can be to load a batch of examples and treat them all as a candidate set and/or to group all notifications sent to the same user over some period of time together.

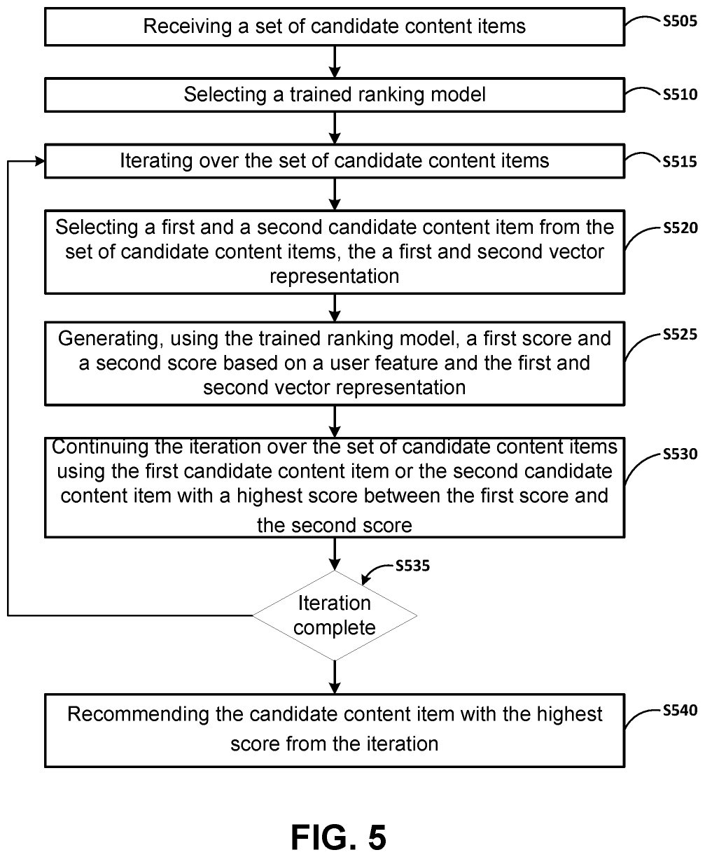

FIG. 5 illustrates a block diagram of a method for generating a push notification according to an example implementation. As shown in FIG. 5 in step S505 a set of candidate content items is received. For example, candidate content items can include documents, web pages, blogs, podcasts, posts, social media posts/replies, and/or the like. The candidate content items can be new (e.g., not viewed by a user) content items. The candidate content items relevant for a push notification.

In step S510 a trained ranking model is selected. In an example implementation the selected trained model and/or a plurality of ranking models can be trained using a loss calculated based on weightings of pairwise rankings of pairs of training content items selected from a set of training content items and each weighting of a pairwise ranking represents a probability of receiving a negative response to a recommended content item if the pair of the pairwise ranking is mis-ordered in a ranking of the set of training content items. The weighting of a pairwise rankings of a pair can be based on a probability of a user opening a push notification associated with a training content item of the of pairs of training content items, a cumulative distribution function for the probability of the user opening the push notification in the set of training candidate content items, and a number of training content items in the set of training candidate content items. A negative response can be incurred if a pair was not ordered correctly in the ranking (e.g., resulting in a push notification associated with a content item that is not of interest to the user). The loss can be over pseudo-candidate sets, such that different ranking models are trained for different user types. A pseudo-candidate set can include using a batch of candidate content items and grouping the candidate content items by user type. The probability of the user opening the push notification associated with the training content item corresponds to a click through rate (CTR) for the training content item being predicted as a top ranked candidate.

In step S515 the set of candidate content items are iterated. For example, steps S520 to S530 can be iterated until all of the candidate content items are tested using the trained ranking model.

In step S520 selecting a first and a second candidate content item are selected from the set of candidate content items. For example, the trained ranking model can use a pairwise expected negative response technique. Therefore, two candidate content items can be selected from the set of candidate content items and tested (e.g., compared) using the pairwise expected negative response technique. The first and the second candidate content item can have a first and a second vector representation. The first and the second candidate content item can include features related to information associated with the content. The features can be converted to a vector form or form similar to the form of the user feature(s) 205. The content can be documents, web pages, blogs, podcasts, posts, social media posts/replies, and/or the like. Therefore, content feature(s) can include, for example, the author or topic of the document, web pages, blogs, podcasts, posts, social media posts/replies, and/or the like. The candidate items can be a combination of user feature and the content feature(s). User feature(s) can be feature variables representing interest, relevance, personalization, significance, and/or the like to a user. The user feature(s) can be a vector or an array of scalar values, each value representing a feature. For example, a vector for a social network can have vector variables associated with a user's likes, dislikes, follow topics, search topics, and/or the like.

In step S525 a first and a second score are generated, using the trained model, based on a user feature and the first and the second vector representation. The score can be based on a predicted click through rate (CTR). The content item with the highest score can correspond with a content item to be communicated with a push notification. The content item with the highest score can be the content item having the highest predicted CTR. Content items not associated with the highest score or highest ranking order may not be used (e.g., insignificant, not relevant) for purposes of push notifications.

In step S530 the iteration of the set of candidate content items is continued using one of the first candidate content item and the second candidate content item with a lowest expected negative response. The first and the second score can be used to select the best (e.g., highest ranking) of the first candidate content item and the second candidate content item that could be used in a push notification. The lower ranking or lowest score candidate content item can effectively be discarded with regard to the ranking of the received candidate content items. Therefore, the iterating can continue using the higher ranking or highest scoring candidate content item.

In response to completing the iteration of the set of candidate content items (step S535), In step S540 the candidate content item with the highest score from the iteration is recommended. Completing the iteration of the set of candidate content items can include testing whether or not all of the candidate content items have been ranked using the pairwise ranking technique. If all of the candidate content items have been ranked using the pairwise ranking technique the last remaining candidate content item (e.g., the higher ranking or highest scoring candidate content item of the last iteration) can be communicated using a push notification.

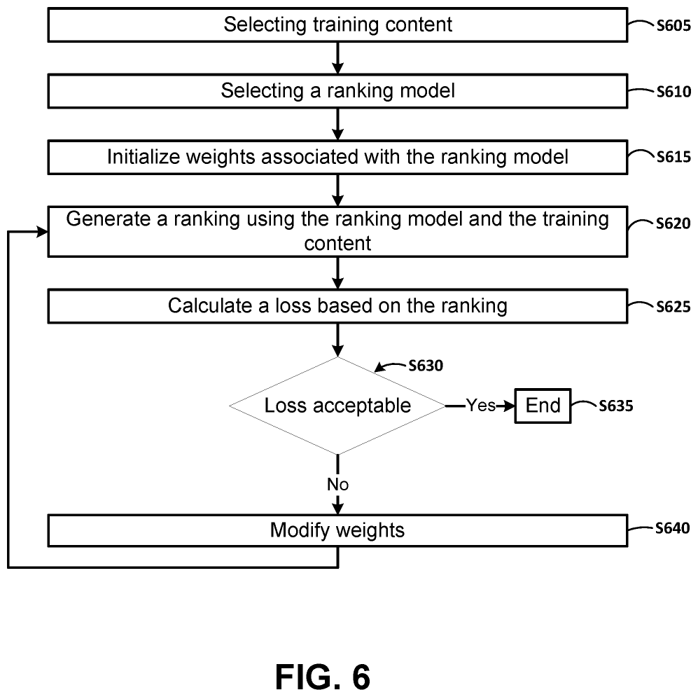

FIG. 6 illustrates a block diagram of a method for training a ranking model according to an example implementation. In step S605 training content is selected. the training content can be historical content items that can be used to train at least one ranking model. For example, training content items can be historical social media posts/replies and candidate content items can be, for example, current or live social media posts/replies. The training content can include ground truth information. The candidate content can be operational content and/or testing content.

In step S610 a ranking model is selected. The ranking model can be or can include a neural network (e.g., deep-learning, a two-dimensional (2D) convolutional neural network (CNN), etc.). The ranking model can be selected from a library of ranking models or a new ranking model (e.g., never trained). In step S615 weights associated with the ranking model are initialized. The weights can be randomly initialized prior to training. In another implementation, a function can be defined by parameters θ (e.g., numeric variables). For example, the function can be a linear function. In this implementations, initializing weights can include initializing θ (e.g., numeric variables).

In step S620 a ranking is generated using the ranking model and the training content. For example, content corresponding to the training content can be content that can be ranked based on interest, relevance, personalization, significance, and/or the like to a user. Content items corresponding to the training content can include documents, web pages, blogs, podcasts, posts, social media posts/replies, and/or the like. Therefore, training content items can be, for example, historical social media posts/replies and candidate content 110 can be, for example, current or live social media posts/replies. The ranking model can be trained by modifying weights associated with the model being trained. The ranking model can be trained for distinguishing between features of the content items and identifying relationships between features and a user (e.g., the user that a push notification may be sent to). The ranking model can have an associated weight(s). As mentioned above, the associated weight(s) can be randomly initialized and then revised in each training iteration (e.g., epoch). The training can be associated with implementing (or helping to implement) distinguishing between two or more content items and identifying relationships (e.g., interest) between content items and users. In an example implementation, a labeled input content items set (e.g., documents with labels indicating a ranking order of the documents and/or the highest ranked document) and the predicted ranking can be compared. A loss can be generated based on the difference between the labeled ranking and the predicted ranking. Training iterations can continue until the loss is minimized and/or until loss does not change significantly from iteration to iteration. In an example implementation, the lower the loss, the better the predicted ranking.

In step S625 a loss is calculated based on the ranking. For example, the loss can be calculated according to equation (5) described above. Training the ranking model can include modifying the weights associated with ranking loss of equation (5). For example, the ranking model can be trained to achieve the best ranking that results in identifying a single content item, of a large corpus of content items, that would be served in a push notification. Content corresponding to the training content can be content that can be ranked based on interest, relevance, personalization, significance, and/or the like to a user. The loss can be calculated by combining pointwise losses and pairwise losses and using a logistic regression (see, for example, algorithm 2)

In step S630 whether or not the loss is acceptable is determined. In response to determining the loss is acceptable, in step S635 the process ends. In response to determining the loss is not acceptable, in step S640 the weights are modified and processing returns to step S620. Whether or not the loss is acceptable can be comparing the loss calculated using equation (5) to a threshold value. In an example implementation, the loss should be below the threshold value.

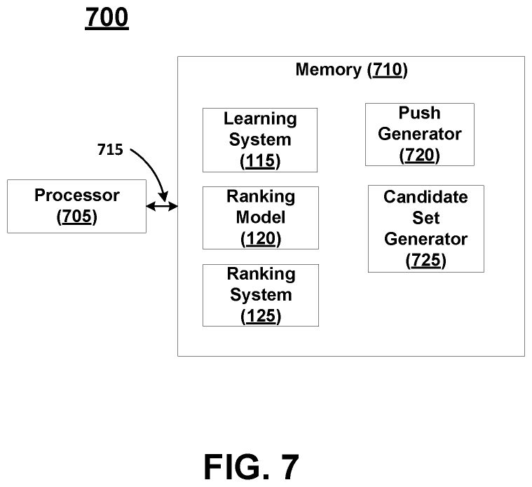

FIG. 7 illustrates a block diagram of a system 700 for generating a push notification according to an example implementation. In the example of FIG. 7, the system 700 can include a computing system or at least one computing device and should be understood to represent virtually any computing device configured to perform the techniques described herein. As such, the device may be understood to include various components which may be utilized to implement the techniques described herein, or different or future versions thereof. By way of example, the system can include a processor 705 and a memory 710 (e.g., a non-transitory computer readable memory). The processor 705 and the memory 710 can be coupled (e.g., communicatively coupled) by a bus 715.

The processor 705 may be utilized to execute instructions stored on the at least one memory 710. Therefore, the processor 705 can implement the various features and functions described herein, or additional or alternative features and functions. The processor 705 and the at least one memory 710 may be utilized for various other purposes. For example, the at least one memory 710 may represent an example of various types of memory and related hardware and software which may be used to implement any one of the modules described herein.

The at least one memory 710 may be configured to store data and/or information associated with the device. The at least one memory 710 may be a shared resource. Therefore, the at least one memory 710 may be configured to store data and/or information associated with other elements (e.g., image/video processing or wired/wireless communication) within the larger system. Together, the processor 705 and the at least one memory 710 may be utilized to implement the techniques described herein. As such, the techniques described herein can be implemented as code segments (e.g., software) stored on the memory 710 and executed by the processor 705. Accordingly, the memory 710 can include the learning system 115, the ranking model(s) 120, the ranking system 125, a push generator 720, and a candidate set generator 725.

The push generator 720 can be configured to generate a push notification based on ranked content items. The candidate set generator 725 can be configured to combine user feature(s) with content feature(s). Generating a candidate set is described in more detail above.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an, and, the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method of recommending a content item from a set of content items, the method comprising:
receiving a set of candidate content items;
training a plurality of ranking models using a loss calculated based on weightings of pairwise rankings of pairs of training content items selected from a set of training content items, wherein each weighting of a pairwise ranking represents a probability of receiving a negative response to a recommended content item if the pair of the pairwise ranking is misordered in a ranking of the set of training content items;
selecting a trained ranking model from the plurality of models;
iterating over the set of candidate content items, including:
selecting a first candidate content item from the set of candidate content items, the first candidate content item having a first vector representation;
selecting a second candidate content item from the set of candidate content items, the second candidate content item having a second vector representation;
generating, using the selected trained ranking model, a first score based on a user feature and the first vector representation;
generating, using the selected trained ranking model, a second score based on the user feature and the second vector representation; and
continuing the iteration over the set of candidate content items using the first candidate content item or the second candidate content item with a highest score between the first score and the second score; and
in response to completing the iteration over the set of candidate content items, recommending the candidate content item with the highest score from the iteration.

2. The method of claim 1, wherein the weighting of a pairwise rankings of a pair is based on a probability of a user opening a push notification associated with a training content item of the of pairs of training content items, a cumulative distribution function for the probability of the user opening the push notification in the set of training candidate content items, and a number of training content items in the set of training candidate content items.

3. The method of claim 2, wherein the probability of the user opening the push notification associated with the training content item corresponds to a click through rate (CTR) for the training content item being predicted as a top ranked candidate.

4. The method of claim 1, wherein
the generating of the first score includes estimating a CTR for the first candidate content item, and
the generating of the second score includes estimating a CTR for the second candidate content item.

5. The method of claim 1,
wherein, for each of the plurality of ranking models, the training of the ranking model includes selecting a group of training content items from a plurality of training content items, wherein the selected group of training content items is based on a user type associated with the selected content items, the loss used to train the ranking model is based on weightings of pairwise rankings of pairs of training content items selected from the selected group of training content items, and each weighting of a pairwise ranking represents a probability of receiving a negative response to a recommended content item if the pair of the pairwise ranking is misordered in a ranking of the selected group of training content items.

6. The method of claim 1, wherein recommending the content item with the highest score includes communicating a push notification associated with the recommended content item to a user.

7. The method of claim 1, wherein the training of the trained ranking models comprises:
combining pointwise losses and pairwise losses; and
using a logistic regression.

8. The method of claim 1, wherein the loss is calculated as:
lₑᵣ(u,θ)=Σ_{X}_{ₚₒₛ}E_{X}_{_{neg}}wₑᵣ(xₚₒₛx_{neg})×max(pairwise loss)
where:
xₚₒₛ is a value representing a content item with a positive response,
x_{neg} is a value representing a content item with a negative response, and
pairwise loss represents a function for a pairwise loss algorithm.

9. The method of claim 1, further comprising:
comparing the highest score to a threshold value; and
in response to determining the highest score is greater than or equal to the threshold value, recommending the content item with the highest score to a user through communication of a push notification associated with the recommended content item.

10. The method of claim 1, wherein recommending the content item with the highest score includes communicating a push notification associated with the recommended content item to a user, and the method further comprising:
determining whether or not the push notification was responded to; and
in response to determining the push notification was not responded to, updating the user feature.

11. The method of claim 1, wherein recommending the content item with the highest score includes communicating a push notification associated with the recommended content item to a user in a social media platform, wherein the user feature represents interactions of the user with the social media platform.

12. The method of claim 11, wherein the probability of receiving the negative response to the recommended content item represents a likelihood the user will disregard or reject the recommended candidate content item.

13. A non-transitory computer-readable storage medium comprising instructions stored thereon that, when executed by at least one processor, are configured to cause a computing system to:
receive a set of candidate content items;
train a plurality of ranking models using a loss calculated based on weightings of pairwise rankings of pairs of training content items selected from a set of training content items, wherein each weighting of a pairwise ranking represents a probability of receiving a negative response to a recommended content item if the pair of the pairwise ranking is misordered in a ranking of the set of training content items;
select a trained ranking model from the plurality of models;
iterate over the set of candidate content items, including:
selecting a first candidate content item from the set of candidate content items, the first candidate content item having a first vector representation;
selecting a second candidate content item from the set of candidate content items, the second candidate content item having a second vector representation;
generate, using the selected trained ranking model, a first score based on a user feature and the first vector representation;
generate, using the selected trained ranking model, a second score based on the user feature and the second vector representation; and
continuing the iteration over the set of candidate content items using the first candidate content item or the second candidate content item with a highest score between the first score and the second score; and
in response to completing the iteration over the set of candidate content items, recommending the candidate content item with the highest score from the iteration.

14. The non-transitory computer-readable storage medium of claim 13, wherein the weighting of a pairwise rankings of a pair is based on a probability of a user opening a push notification associated with a training content item of the of pairs of training content items, a cumulative distribution function for the probability of the user opening the push notification in the set of training candidate content items, and a number of training content items in the set of training candidate content items.

15. The non-transitory computer-readable storage medium of claim 14, wherein the probability of the user opening the push notification associated with the training content item corresponds to a click through rate (CTR) for the training content item being predicted as a top ranked candidate.

16. The non-transitory computer-readable storage medium of claim 13, wherein
the generating of the first score includes estimating a CTR for the first candidate content item, and
the generating of the second score includes estimating a CTR for the second candidate content item.

17. The non-transitory computer-readable storage medium of claim 13,
wherein, for each of the plurality of ranking models, the training of the ranking model includes selecting a group of training content items from a plurality of training content items, wherein the selected group of training content items is based on a user type associated with the selected content items, the loss used to train the ranking model is based on weightings of pairwise rankings of pairs of training content items selected from the selected group of training content items, and each weighting of a pairwise ranking represents a probability of receiving a negative response to a recommended content item if the pair of the pairwise ranking is misordered in a ranking of the selected group of training content items.

18. The non-transitory computer-readable storage medium of claim 13, wherein recommending the content item with the highest score includes communicating a push notification associated with the recommended content item to a user.

19. The non-transitory computer-readable storage medium of claim 13, wherein recommending the content item with the highest score includes communicating a push notification associated with the recommended content item to a user, and the instructions further comprising:
determining whether or not the push notification was responded to; and
in response to determining the push notification was not responded to, updating the user feature.

20. The non-transitory computer-readable storage medium of claim 13, wherein recommending the content item with the highest score includes communicating a push notification associated with the recommended content item to a user in a social media platform, wherein the user feature represents interactions of the user with the social media platform.
